(19) United States
(12) Patent Application Publication
(10) Pub. No.: US 2008/0122963 A1
(43) Pub. Date: May 29, 2008

(54) SOLID-STATE IMAGING APPARATUS

(75) Inventor: Taishin YOSHIDA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/872,996

(22) Filed: Oct. 16, 2007

(30) Foreign Application Priority Data
Oct. 17, 2006 (JP) 2006-282359

(51) Int. Cl. H04N 5/335

(52) U.S. Cl. 348/308; 348/E05.091

(57) ABSTRACT

A solid-state imaging apparatus including: a pixel section where a plurality of unit pixels each having a first pixel and a second pixel adjacent to the first pixel are two-dimensionally arranged; an image forming control means for forming substantially the same object image on the first pixel and on the second pixel; and an image signal generation means for generating an image signal associated with an object at the unit pixel based on a signal from the first pixel and a signal from the second pixel.

This application claims benefit of Japanese Patent Application No. 2006-282359 filed in Japan on Oct. 17, 2006, the contents of which are incorporated by this reference.

### BACKGROUND OF THE INVENTION

The present invention relates to solid-state imaging apparatus having a concurrent shutter (also referred to as global shutter) function and being adapted so that shading correction can be more accurately effected in one using a method where a pixel signal obtained by differentiating two pixels is outputted as imaging signal.

Among the drive methods of MOS-type solid-state imaging device, there is a known method where all pixels are concurrently reset to accumulate signal and accumulated signals are concurrently transferred to memory, the signals transferred to the memory being sequentially read out. A description will first be given to such a method where a concurrent reset and concurrent transfer are effected and reading is effected sequentially (hereinafter referred to as global shutter read).

FIG. 1 is a circuit diagram showing a general pixel construction to be used in MOS solid-state imaging device. What is denoted by 600 in FIG. 1 is a single pixel. The pixel 600 includes: a photodiode 606 for effecting photoelectric conversion; a transfer transistor 602 for transferring signal charge generated at the photodiode 606 to a memory 605; a reset transistor 601 for resetting the memory 605 and photodiode 606; an amplifier (transistor) 604 for amplifying and reading voltage level of the memory 605; and a select transistor 603 for selecting the pixel to transmit an output of the amplifier 604 to a vertical signal line 614. These components but the photodiode 606 are shielded from light.

Also referring to FIG. 1, what is denoted by 610 is a pixel power supply, which is electrically connected to drain of the amplifier 604 and to drain of the reset transistor 601. 611 is a reset line for resetting pixels corresponding to one row, which is electrically connected respectively to the gate of reset transistor 601 of the pixels corresponding to one row. 612 is a transfer line for transferring signal charge generated at photodiode 606 of pixels corresponding to one row to the memory 605 of the respective pixels, which is electrically connected respectively to the gate of the transfer transistors 602 corresponding to one row. 613 is a select line for selecting pixels corresponding to one row, which is electrically connected respectively to the gate of the select transistors 603 corresponding to one row. With the pixel construction using four transistors in this manner (hereinafter referred to as 4-Tr pixel), a photoelectric conversion function, reset function, amplification/read function, temporary memory function, and select function are achieved.

FIG. 2 is a block diagram showing a general fundamental construction of MOS solid state imaging device where the global shutter read is made possible with using pixels having the construction shown in FIG. 1. A light receiving section is formed of a pixel section 700 where a plurality of the pixel 600 shown in FIG. l are arranged into M rows and N columns. A vertical scanning circuit 704 is to sequentially output row by row to the pixel section 700 a row select signal ΦSEL-i (i=1, 2, 3, . . . M), row reset signal ΦRS-i, and row transfer signal ΦTx-i, or to simultaneously output row reset signal ΦRS-i and row transfer signal ΦTX-i to all rows. From the vertical scanning circuit 704 at this time, the row select signal ΦSEL-i is transmitted to the gate of the select transistor 603 of the pixels of i-th row through the select line 613, the row reset signal ΦRS-i is transmitted to the gate of the reset transistor 601 of the pixels of i-th row through the reset line 611, and the row transfer signal ΦTX-i is transmitted to the gate of the transfer transistor 602 of the pixels of i-th row through the transfer line 612.

When signals of the pixels of i-th row are to be read out, the row select signal ΦSEL-i of i-th row is inputted to the pixel section 700 from the vertical scanning circuit 704. When the photodiodes 606 of the pixels of i-th row are to be reset, the row reset signal ΦRS-i and row transfer signal ΦTx-i of i-th row are inputted to the pixel section 700 from the vertical scanning circuit 704. When the memory 605 of the pixels of i-th row is to be reset, the row reset signal ΦRS-i of i-th row is inputted to the pixel section 700 from the vertical scanning circuit 704. When signal charges of photodiode 606 of the pixels of i-th row are to be transferred to the memory 605, the row transfer signal ΦTX-i of i-th row is inputted to the pixel section 700 from the vertical scanning circuit 704.

The signals of the selected and read out pixels of i-th row are subjected to such processing as FPN (fixed pattern noise) cancel at a row parallel processing circuit 701, and the results of processing thereof are stored to a line memory 702. Subsequently, a horizontal scanning circuit 703 outputs horizontal select signals ΦH-j (j=1, 2, 3, . . . N) to scan and read while sequentially selecting pixel signals corresponding to one row stored at the line memory 702. By sequentially effecting this processing from the first to M-th rows of the pixel section 700, the signals of all pixels of the pixel section 700 can be scanned and read out.

A description will now be given by way of a drive timing chart of FIG. 3 with respect to the global shutter read of the solid-state imaging device shown in FIG. 2. First, as the row reset signals ΦRS−1 to ΦRS-M of all rows and row transfer signals ΦTx−1 to ΦTx-M of all rows are simultaneously outputted from the vertical scanning circuit 704, the photodiodes 606 of the pixels corresponding to all rows are reset. Subsequently, after a certain signal accumulation period, the row transfer signals ΦTx−1 to ΦTx-M of all rows are simultaneously outputted from the vertical scanning circuit 704. The signal charges accumulated during the signal accumulation period at the photodiodes 606 of the pixels corresponding to all rows are thereby simultaneously transferred of all rows to the memory 605 of the pixels corresponding to all rows. Based on such operation, a global shutter operation is effected.

Next, a row-by-row read operation of signals stored at the memory 605 of all pixels 605 is started. First, as ΦSEL−1 is outputted from the vertical scanning circuit 704, pixels of the first row are selected and signal levels of the pixels are read out. Further, as row reset signal ΦRS−1 of the first row is outputted from the vertical scanning circuit 704 while the pixels of the first row are being selected, the memories 605 of the first row are reset and reset levels of the pixels thereof are read out. When the reading of signals of the pixels of the first row is complete, pixels of the second row are selected and the signal levels and reset levels thereof are similarly read out.

Thus read out signals of the pixels of i-th row (i=1, 2, 3, . . . M) are subjected to such processing as FPN (fixed pattern noise) cancel at the row parallel processing circuit 701, the results of such processing are stored to the line memory 702. Subsequently, the horizontal scanning circuit 703 outputs horizontal select signal ΦH-j (j=1, 2, 3, . . . N) so that the pixel signals corresponding to one row stored at the line memory 702 are scanned and read out while being sequentially selected. By sequentially effecting this processing from the first to M-th row, signals of all pixels of the pixel section 700 can be scanned and read out.

While horizontal select signals ΦH-j (J=1, 2, 3, . . . N) of the horizontal scanning circuit 703 is omitted and not shown in FIG. 3 for ease of explanation, the horizontal select signals ΦH-j are outputted in the duration from the reading of signals of i-th row to the reading of signals of (i+1)-th row.

In the global shutter read described above, the retaining time of the signals retained at the memory 605 are different from one row to another as shown in FIG. 3, and the signal retaining time becomes longer for those which are read out late. In particular, the signal retaining time of the second row is longer than the signal retaining time of the first row by the period for reading signals corresponding to one row, and the signal retaining time of M-th row is longer than the signal retaining time of the first row by the period for reading signals corresponding (M−1) rows. For this reason, if a leak current occurs at the memory 605 or if light is irradiated on the memory 605 during the period of retaining signal at the memory, an unnecessary electric charge is consequently retained at the memory 605 in addition to the necessary signal from the photodiode 606. Since such unnecessary electric charge is increased as the time for retaining signal at the memory 605 becomes longer, it has been manifest as shading in the direction of rows. As a method for solving this, a technique as shown in FIG. 4 has been disclosed in Japanese Patent Application Laid-Open 2006-108889.

A description will now be given with using the drive timing shown in FIG. 4 of the technique disclosed in the above publication with which shading as described above that occurs at the time of global shutter read can be corrected. It should be noted that the construction of the solid-state imaging device itself is shown in FIG. 2. First, as the row reset signals ΦRS−1 to ΦRS-M of all rows and the row transfer signals ΦTx−1 to ΦTx-M of all rows are simultaneously outputted from the vertical scanning circuit 704, the photodiodes 606 of the pixels corresponding to all rows are reset. Subsequently, after passage of a certain signal accumulation period, as row transfer signals ΦTx−1, ΦTx−3, ΦTx−5, . . . , ( Tx-(2m−1) of odd-number rows are simultaneously outputted from the vertical scanning circuit 704, the signal charges accumulated in the signal accumulation period at photodiodes 606 of the pixels of the odd-number rows are simultaneously transferred to the memory 605 of the pixels of the odd-number rows. At this time, since row transfer signals ΦTx−2, ΦTx−4, . . . , ΦTx-(2m) of even-number rows are not outputted, the signals accumulated at photodiodes 606 of the pixels of the even-number rows are not transferred to the memory 605.

Next, a row-by-row read operation of signals stored at the memory 605 of all pixels is started. First, as row select signal ΦSEL−1 of the first row is outputted from the vertical scanning circuit 704, pixels of the first row are selected and signal levels of the pixels are read out. Further, as reset signal RS−1 of the first row is outputted from the vertical scanning circuit 704, the memories 605 of the pixels of the first row are reset and reset levels of the pixels are read out. When the reading of signals of the pixels of the first row is complete, pixels of the second row are selected and the signal levels and reset levels thereof are similarly read out.

Thus read out signals of the pixels of i-th row (i=1, 2, 3, . . . M) are subjected to such processing as FPN (fixed pattern noise) cancel at the row parallel processing circuit 701, and the results of such processing are stored to the line memory 702. Subsequently, the horizontal scanning circuit 703 outputs horizontal select signal ΦH-j (j=1, 2, 3, . . . N) so that the pixel signals corresponding to one row stored at the line memory 702 are scanned and read out while being sequentially selected. By sequentially effecting this processing from the first to M-th rows, the signals of all pixels of the pixel section 700 can be scanned and read out.

While horizontal select signals ΦH-j of the horizontal scanning circuit 703 is omitted and not shown in FIG. 4 for ease of explanation, the horizontal select signals ΦH-j (J=1, 2, 3, . . . N) are outputted in the duration from the reading of signals of i-th row to the reading of signals of (i+1)-th row.

With such read method, too, the retaining time of signals retained at the memory 605 of each pixel are different from one row to another so that the signal retaining time similarly: becomes longer for those rows to be read out late and the shading due to unnecessary electric charge does occur. Here, the components of signal accumulated at photodiode 606 and unnecessary electric charge are contained in the signals read out from the odd-number rows, and the component only of unnecessary electric charge is contained in the signals read out from the even-number rows that are adjacent to the odd-number rows. In particular, supposing Q(2i−1) as signal of pixel of a certain odd-number row, Qpd(2i−1) as signal component accumulated at photodiode 606, and Qn(2i−1) as unnecessary electric charge component, and also supposing Q(2i) as signal of pixel of adjacent even-number row, and Qn(2i) as unnecessary electric charge component, the signal Q(2i−1) of the odd-number row and the signal Q(2i) of the even-number row may be expressed as follows.

Q(2i-1)=Qpd(2i-1)+Qn(2i-1)

Q(2i)−Qn(2i)

Here, the unnecessary electric charge component Qn(2i−1) of the odd-number row and the unnecessary electric charge component Qn(2i) of the adjacent even-number row are substantially the same when the number of rows of the pixel section is very large, since the signal retaining time may be regarded as substantially the same between adjacent rows. Accordingly, the differential between the odd-number row signal Q(2i−1) and the adjacent even-number row signal Q(2i) may be approximated as Q(2i−1)−Q(2i)≈Qpd(2i−1).

In other words, the signal transferred from photodiode 606 to memory 605 can be obtained by differentiating signal of an odd-number row (light signal row) where global shutter read operation is effected and signal of an even-number row (correction signal row) adjacent thereto where signal of photodiode 606 is not transferred to the memory 605, whereby the shading due to unnecessary electric charge can be eliminated.

### SUMMARY OF THE INVENTION

In a first aspect of the invention, there is provided a solid-state imaging apparatus including: a pixel section where a plurality of unit pixels each having a first pixel and a second pixel adjacent to the first pixel are two-dimensionally arranged; an image forming control means for forming substantially the same object image on the first pixel and on the second pixel; and an image signal generation means for generating an image signal associated with an object at the unit pixel based on a signal from the first pixel and a signal from the second pixel.

In a second aspect of the invention, the image forming control means in the solid-state imaging apparatus according to the first aspect is an optical low-pass filter placed on an optical path of the object image.

In a third aspect of the invention, the image forming control means in the solid state imaging apparatus according to the first aspect is an optical path changing means for changing an optical path of the object image in relation to the pixel section according to time.

### BRIEF DESCRIPTION OF THE DRAWINGS

FIG. 1 is a circuit diagram showing a pixel construction of prior-art MOS solid-state imaging apparatus.

FIG. 2 is a block diagram showing a fundamental construction of MOS solid-state imaging device with which a prior-art global shutter read is possible.

FIG. 3 is a timing chart for explaining drive mode at the time of a concurrent shutter (global shutter) read operation of MOS solid-state imaging device shown in FIG. 2.

FIG. 4 is a timing chart for explaining drive mode adapted so as to make shading correction possible in the concurrent shutter read operation of MOS solid-state imaging device shown in FIG. 2.

FIG. 5 is a conceptual drawing for showing an outline of the solid-state imaging apparatus according to the invention.

FIG. 6 is a schematic block diagram showing a main portion of a first embodiment of the solid-state imaging apparatus according to the invention.

FIG. 7 explains a shift amount of optical path in the first embodiment shown in FIG. 6.

FIG. 8 is a schematic block diagram showing a main portion of the solid-state imaging apparatus according to a second embodiment of the invention.

FIG. 9 is a schematic block diagram showing a main portion of the solid-state imaging apparatus according to a third embodiment of the invention.

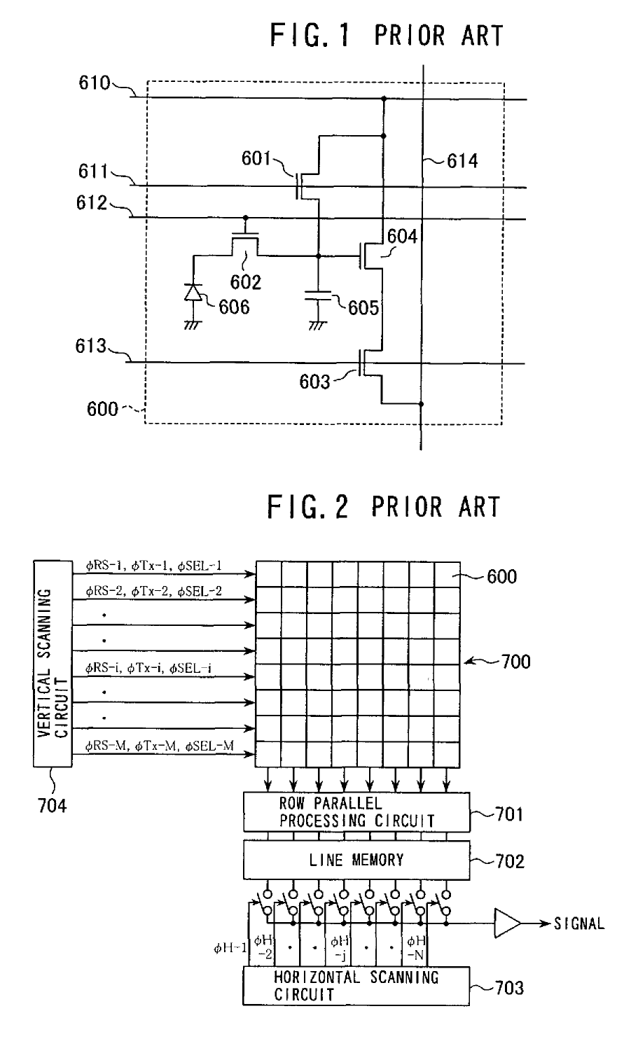

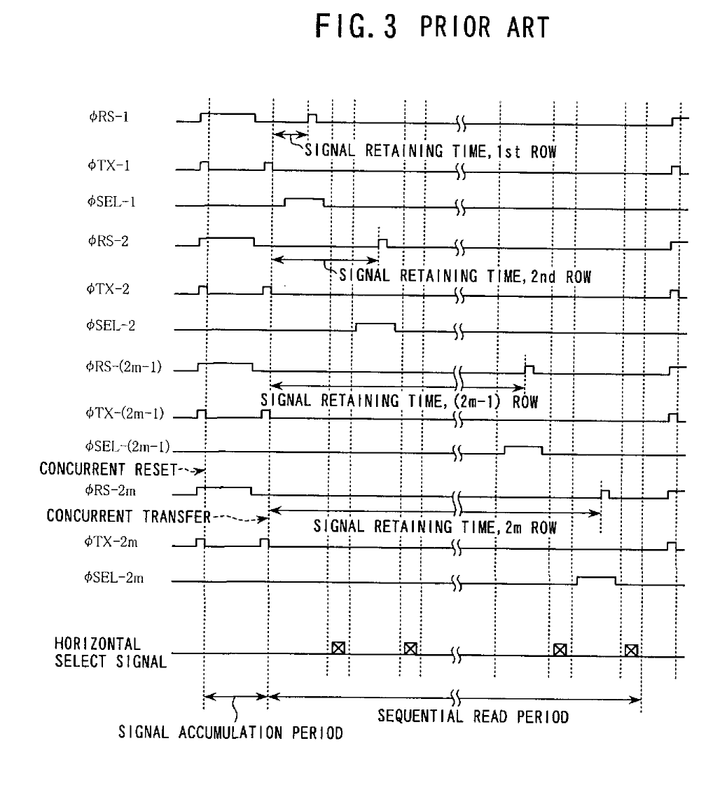

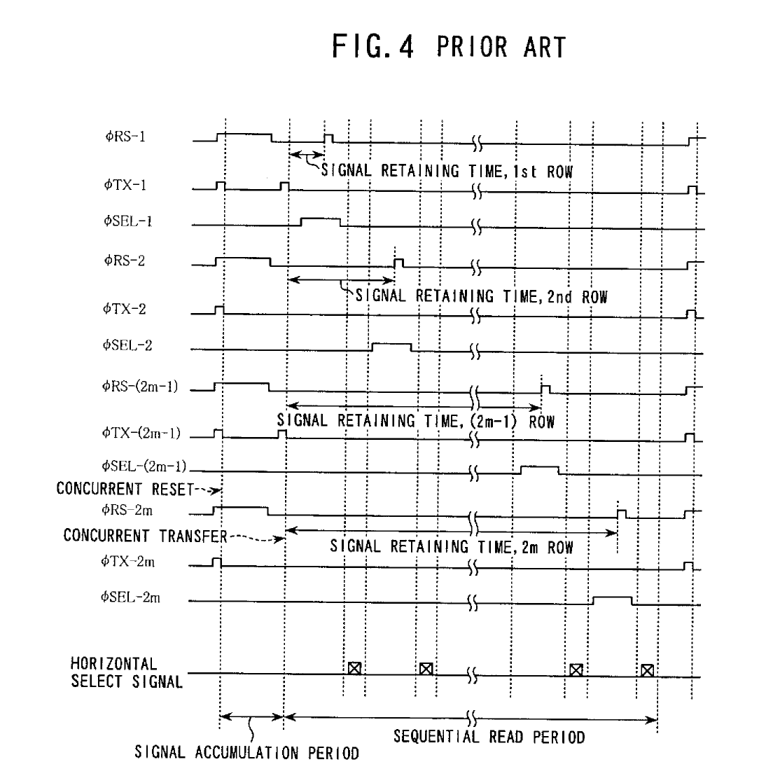

### DESCRIPTION OF THE PREFERRED EMBODIMENTS

Some embodiments of the solid-state imaging apparatus according to the invention will be described below with reference to the drawings.

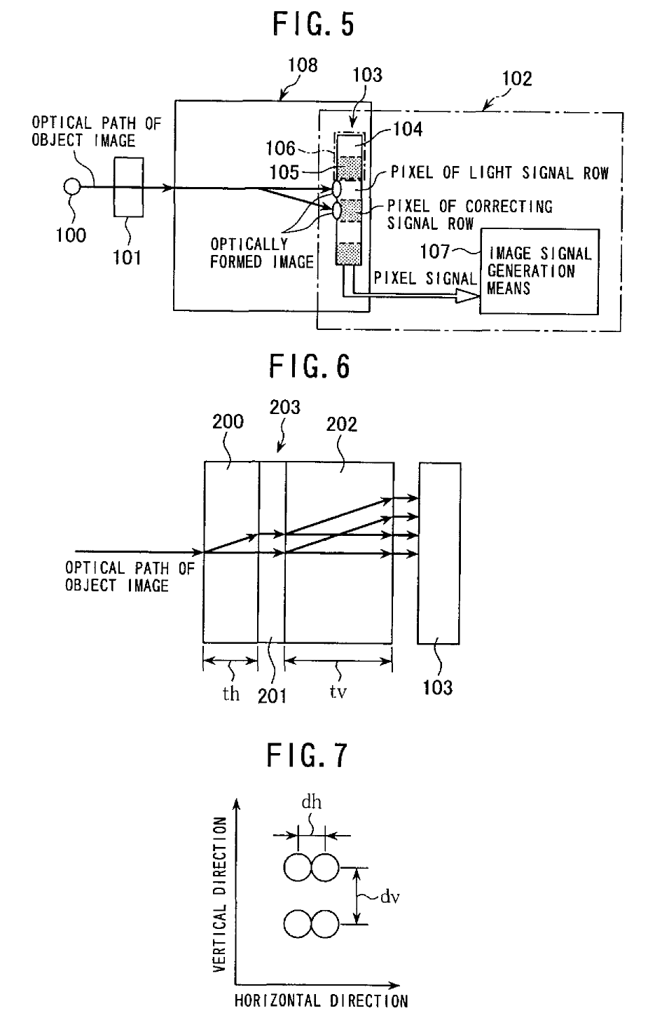

Before explaining a specific embodiment of the solid-state imaging apparatus according to the invention, outlines of the solid-state imaging apparatus according to the invention will now be described by way of a conceptual drawing shown in FIG. 5. FIG. 5 includes: 100, an object; 101, an optical system; 102, a solid-state imaging device; 103, a pixel section; 104, a first pixel (pixel of light signal row); 105, a second pixel (pixel of correction signal row); 106, a unit pixel consisting of the first and second pixels 104, 105; 107, an image signal generation means for generating a signal by differentiation between signal from the first pixel and signal from the second pixel as image signal of the unit pixel 106; and 108, an image forming control means for forming an image of scattering light (object image) from the object in an image forming plane. It is so adapted that substantially the same object image is formed on an adjacent first pixel and second pixel by the image forming control means 108. The image forming plane is a surface (light receiving plane) of the pixel section 103 of the solid-state imaging device 102. It should be noted that the pixel section 103 is composed of a plurality of unit pixels 106 that are two-dimensionally arranged.

The solid-state imaging apparatus according to the invention is composed of the image forming control means 108 for forming substantially the same object image on the first pixel 104 and on the second pixel 105 that are adjacent to each other so as to constitute a unit pixel 106, and the solid-state imaging device 102 shown in FIG. 2 (its components but the pixel section 103 being not shown in FIG. 5) including the image signal generation means 107. The scattering light from the object 100 (object image) is formed into an image at the pixel section 103 through the optical system 101. At this time, the relative position between the optically formed image and the pixel section 103 is changed by the image forming control means 108.

With such construction, it is possible as shown in FIG. 5 to form substantially the same object image at first pixels (light signal row) and at second pixels (correcting signal row) of the pixel section. The amount of unnecessary electric charge generated at each pixel due to leakage of light thereby becomes substantially the same between the first pixel and the second pixel that are adjacent to each other so that the shading can be corrected more accurately.

The shading is corrected by effecting such as a differential processing between pixel signal of the first pixel and pixel signal of the second pixel that are adjacent to each other so as to eliminate unnecessary electric charge components occurring for example due to light leakage. The image forming control means 108 may be of any types including an optical low-pass filter or an optical path changing means to be described in detail in the following which are capable of changing the relative position between the optically formed image and the pixel section.

### Embodiment 1

A first specific embodiment of the solid-state imaging apparatus according to the invention will now be described. FIG. 6 shows construction of the image forming control means and solid-state imaging device constituting a main portion of the solid-state imaging apparatus according to the first embodiment, where construction of the portion not shown in the figure of the solid-state imaging device is identical to the solid-state imaging device shown in FIG. 2. In this embodiment, the image forming control means is composed of an optical low-pass filter 203. Referring to FIG. 6, what is denoted by 200 is a crystal (birefringent material such as calcite) which is disposed so that its crystal axis is horizontal. It has a function for splitting into an ordinary ray and an extraordinary ray according to the components of polarization of an incident light (object image). The split amount (dh) is proportional to its thickness “th”. The incident light is a natural light (randomly polarized light) of which horizontally polarized component has an optical path shifted by birefringence (extraordinary ray) and vertically polarized component is transmitted without shift (ordinary ray).

Also referring to FIG. 6, what is denoted by 201 is a wavelength plate which changes polarization state (from a linearly polarized light to circularly polarized light). In particular, while the extraordinary ray transmitted through the crystal 200 is linearly polarized in the horizontal direction, it becomes a circularly polarized light by the wavelength plate 201. Further, white the ordinary ray transmitted through the crystal 200 is linearly polarized in the vertical direction, it becomes a circularly polarized light by the wavelength plate 201. Further, what is denoted by 202 is a crystal which is disposed so that its crystal axis is vertically oriented. It has a function for splitting into an ordinary ray and an extraordinary ray according to the components of polarization of an incident light. A sprit amount (dv) thereof is proportional to its thickness “tv”. The ordinary ray and the extraordinary ray transmitted through the wavelength plate 201 are both circularly polarized. A circularly polarized light is one where the linearly polarized lights in the horizontal direction and the vertical direction are shifted in phase by ¼ wavelength from each other. The ordinary ray transmitted through the wavelength plate 201 is split into a new ordinary ray and extraordinary ray in the vertical direction by the crystal 202. Further, the extraordinary ray transmitted through the wavelength plate 201 is also split into a new ordinary ray and extraordinary ray in the vertical direction by the crystal 202.

By using thus constructed optical low-pass filter 203 as the image forming control means, an incident light (object image) is divided into two in the horizontal direction and is further divided into two in the vertical direction so that the light divided in this manner can be caused to be incident on the pixel section 103 of the solid-state imaging device. An adjustment is made at this time as shown in FIG. 7 so that the split amount “dh” in the horizontal direction is of the order of one pixel pitch and the split amount “dv” in the vertical direction is of the order of two pixels consisting of the first pixel and the second pixel that are adjacent to each other. With a setting in this manner, spatial frequency of the incident optical image of the object can be made lower. It is thereby possible to reduce an occurrence of moire in both the horizontal direction and the vertical direction, and to make the optically formed image as substantially the same between the pixels that are adjacent to each other. Accordingly, a more accurate shading correction becomes possible.

### Embodiment 2

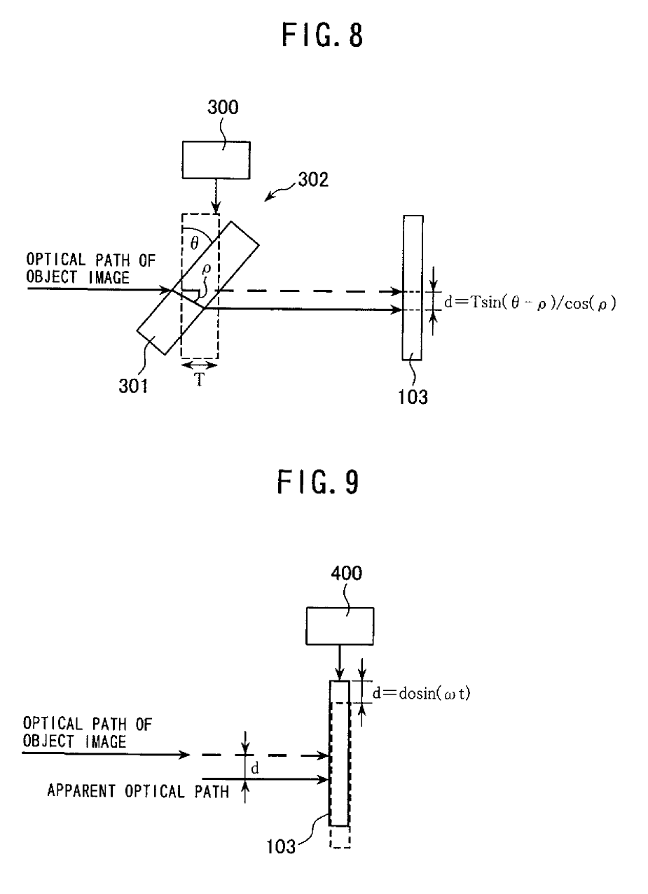

A second specific embodiment of the solid-state imaging apparatus according to the invention will now be described. FIG. 8 shows construction of the image forming control means and solid-state imaging device constituting a main portion of the solid-state imaging apparatus according to the second embodiment, where construction of the portion not shown in the figure of the solid-state imaging device is identical to the solid-state imaging device shown in FIG. 2. In this embodiment, the image forming control means is formed of an optical path changing means 302. In FIG. 8, what is denoted by 300 is an actuator (piezoelectric device, motor, etc.), and 301 is an optical member (having a refractive index n). The actuator 300 is for displacing the optical member 301 according to time. Here, the optical path of light rays (object image) incident on the pixel section 103 of the solid-state imaging device is periodically displaced in the vertical direction of the pixel section 103 (direction along which the first pixel and the second pixel are arranged) by periodically changing an inclination of the optical member 301. A displacement amount θ (θ=ωt, t: time, ω: angular frequency) is determined with considering a thickness T and refractive index n of the optical member 301, and a shift amount d of the optical path on the pixel section 103. Further, the angular frequency ω is set so that the number of times of repetition of displacement is sufficiently large in the period for accumulating signal at the photodiode of each pixel (signal accumulation period) and during the period for retaining signal at the memory of each pixel (signal retaining period). Here, the shift amount d of the optical path in the signal accumulation period is desirably of the order of two pixels corresponding to the first pixel (light signal row) and the second pixel (correction signal row).

It should be noted in respect of the optical member 301 that light (object image) incident on the optical member 301 propagates at an angle of refraction ρ in accordance with an inclination θ of the optical member 301. Since this light after transmitted through the optical member 301 propagates in the same direction as before its incidence on the optical member 301, it is possible to shift the optical path. At this time, there is a relationship of sin (θ)=n×sin(ρ) between the inclination θ and the angle of refraction ρ of the optical member 301 (Snell's law). Further, the shift amount d of the optical path is expressed as d=T×sin(θ−ρ)/cosρ.

In the second embodiment shown in FIG. 8, the optical path changing means 302 consisting of the actuator 300 and optical member 301 is used as the image forming control means so that the optical path is changed by changing by the actuator 300 according to time an inclination of the plate-like optical member 301 through which light is transmitted. As has been described, it is thereby possible to form substantially the same optical image at pixels that are adjacent to each other so that an accurate shading correction is made possible. Here, the optical path changing means may be of any type which changes optical path so as to change by time the optical path for forming an image on the pixel section 103 of the solid-state imaging device. The shape of the optical member 301 is not limited to the plate-like configuration, and a concave or convex lens-like configuration may also be used. Further, it is also possible to change optical path by changing an inclination of a light-reflecting reflector so as to form images on the pixel section 103 of the solid-state imaging device. Furthermore, the direction along which the optical path is displaced is not limited to one dimension such as the direction of arrangement of the first pixel (light signal row) and the second pixel (correcting signal row), and a two-dimensional displacement is also possible.

### Embodiment 3

A third specific embodiment of the solid-state imaging apparatus according to the invention will now be described. FIG. 9 shows construction of a main portion of the solid-state imaging apparatus according to the third embodiment, where construction of the portion not shown in the figure of the solid-state imaging device is identical to the solid-state imaging device shown in FIG. 2. In this embodiment, the solid-state imaging device is displaced according to time to control the image forming position. In FIG. 9, what is denoted by 400 is an actuator (piezoelectric device, motor, etc.) which displaces the position of the pixel section 103 of the solid-state imaging device by time in the direction along which the first pixel (light signal row) and the second pixel (correcting signal row) are arranged.

In this embodiment, an apparent shift amount of the optical path d [d=do×sin(ωt)] is controlled by changing the position of the pixel section 103 of the solid-state imaging device according to time. Here, t is time, ω is angular frequency, and do is amplitude of displacement. The angular frequency ω is set so that the number of times of repetition of displacement is sufficiently large in the period for accumulating signal at the photodiode of pixel (signal accumulation period) and in the period for retaining signal at the memory of pixel (signal retaining period). The shift amount d of the optical path is desirably of the order of two pixels corresponding to the first pixel. (light signal row) and the second pixel (correcting signal row). The direction of displacement is not limited to one dimension such as the direction of arrangement of the first pixel (light signal row) and the second pixel (correcting signal row), and a two-dimensional displacement is also possible.

Also in this embodiment, an accurate shading correction is made possible, since the optical path can be changed in relation to the pixel section 103 so as to form substantially the same optical image at pixels that are adjacent to each other by displacing the solid-state imaging device by time with using the actuator 400.

According to the present invention as has been described by way of the above embodiments, since there is provided an image forming control means for forming substantially the same object image at the first pixel and the second pixel of a unit pixel, the amount of unnecessary electric charge generated at pixel due to leakage of light becomes substantially the same between the first pixel and the second pixel that are adjacent to each other, thereby making a more accurate shading correction possible.

What is claimed is:

1. A solid-state imaging apparatus comprising:
a pixel section where a plurality of unit pixels each having a first pixel and a second pixel adjacent to the first pixel are two-dimensionally arranged;
an image forming control means for forming substantially the same object image on the first pixel and on the second pixel; and
an image signal generation means for generating an image signal associated with an object at the unit pixel based on a signal from the first pixel and a signal from the second pixel.

2. The solid-state imaging apparatus according to claim 1, wherein said image forming control means comprises an optical low-pass filter placed on an optical path of the object image.

3. The solid-state imaging apparatus according to claim 1, wherein said image forming control means comprises an optical path changing means for changing an optical path of the object image in relation to the pixel section according to time.
